(19) United States
(12) Patent Application Publication
(10) Pub. No.: US 2025/0309360 A1
(43) Pub. Date: Oct. 2, 2025

(54) METHOD FOR PRODUCING LAMINATED BATTERY, LAMINATED BATTERY, AND BATTERY PACK

(71) Applicant: TOYOTA JIDOSHA KABUSHIKI KAISHA, Toyota-shi (JP)

(72) Inventor: Kenichi KAKISHITA, Nagoya-shi (JP)

(73) Assignee: TOYOTA JIDOSHA KABUSHIKI KAISHA, Toyota-shi (JP)

(21) Appl. No.: 19/047,331

(22) Filed: Feb. 6, 2025

(30) Foreign Application Priority Data
Apr. 2, 2024 (JP) 2024-059661

(51) Int. Cl. H01M 10/0585; H01M 10/0525; H01M 10/0562

(52) U.S. Cl. CPC H01M 10/0585; H01M 10/0525; H01M 10/0562

(57) ABSTRACT

The present disclosure provides a method for producing a laminated battery whereby the laminated battery units on the outermost sides are resistant to cracking, a laminated battery that can be produced by the method, and a battery pack comprising the laminated battery. The method of the disclosure for producing a laminated battery 10 comprises the following steps: (a) providing a plurality of laminated battery units 100 each comprising a first current collector layer 110, a first electrode active material layer 120, a solid electrolyte layer 130, a second electrode active material layer 140 and a second current collector layer 150 in that order, and (b) stacking together the plurality of laminated battery units so that at least at a first end face of the laminated battery, the end faces of the outermost laminated battery units are situated further inward than the end faces of the other adjacent laminated battery units.

### FIELD

The present disclosure relates to a method for producing a laminated battery, to a laminated battery, and to a battery pack.

### BACKGROUND

It is known that laminated batteries comprise a plurality of laminated battery units, each having a first current collector layer, a first electrode active material layer, a solid electrolyte layer, a second electrode active material layer and a second current collector layer in that order, stacked on one another.

PTL 1 discloses that when a plurality of laminated battery units are stacked, shifting may occur between the laminated battery units in the in-plane direction.

### CITATION LIST

### Patent Literature

[PTL 1] Japanese Unexamined Patent Publication No. 2020-161298

### SUMMARY

### Technical Problem

The present inventors have found that the laminated battery units on the outermost sides of a laminated battery unit may suffer cracking due to the shifting described above.

It is an object of the present disclosure to provide a method for producing a laminated battery whereby the laminated battery units on the outermost sides are resistant to cracking. It is another object of the disclosure to provide a laminated battery wherein the outermost laminated battery units are resistant to cracking, and a battery pack comprising the laminated battery.

### Solution to Problem

The present inventors have found that the aforementioned object can be achieved by the following means.
<Aspect 1>

A method for producing a laminated battery, comprising the following steps:
(a) providing a plurality of laminated battery units each comprising a first current collector layer, a first electrode active material layer, a solid electrolyte layer, a second electrode active material layer and a second current collector layer in that order, and
(b) stacking together the plurality of laminated battery units so that at least at a first end face of the laminated battery, the end faces of the outermost laminated battery units are situated further inward than the end faces of the other adjacent laminated battery units.
<Aspect 2>

The method according to aspect 1, wherein the end faces of the first electrode active material layers, solid electrolyte layers and second electrode active material layers of the plurality of laminated battery units all have inclined surfaces toward their tips, approaching the first current collector layer, and the inclined surfaces are formed at a second end face opposite the first end face of the laminated battery.
<Aspect 3>

The method according to aspect 2, wherein each inclined surface is formed because the lengths between the mutually opposite end faces of the second electrode active material layers are shorter than the lengths between the mutually opposite end faces of the first electrode active material layers.
<Aspect 4>

The method according to any one of aspects 1 to 3, wherein in step (b), the plurality of laminated battery units are stacked together in such a manner that the end faces of the outermost laminated battery units at the second end face opposite the first end face of the laminated battery do not extend from the end faces of the other adjacent laminated battery units.
<Aspect 5>

The method according to aspect 1, wherein in step (b), the positions of the end faces of the outermost laminated battery units at least at the first end face of the laminated battery are determined by image processing.
<Aspect 6>

A laminated battery, comprising a plurality of laminated battery units stacked together, wherein:
each of the plurality of laminated battery units comprises a first current collector layer, a first electrode active material layer, a solid electrolyte layer, a second electrode active material layer and a second current collector layer in that order, and
at least at a first end face of the laminated battery, the end faces of the outermost laminated battery units are situated further inward than the end faces of the other adjacent laminated battery units.
<Aspect 7>

The laminated battery according to aspect 6, wherein the end faces of the first electrode active material layer, the solid electrolyte layer and the second electrode active material layer of the laminated battery unit all have inclined surfaces toward their tips, approaching the first current collector layer, and the inclined surfaces are formed at a second end face opposite the first end face of the laminated battery.
<Aspect 8>

The laminated battery according to aspect 6 or 7, wherein at the second end face opposite the first end face of the laminated battery, the outermost laminated battery units do not extend from the end faces of the other adjacent laminated battery units.
<Aspect 9>

The laminated battery according to any one of aspects 6 to 8, wherein at least at the first end face of the laminated battery, the spacings between the end faces of the outermost laminated battery units and the end faces of the other adjacent laminated battery units are 0.1 mm or greater and 1.0 mm or smaller, as viewed in the in-plane direction.
<Aspect 10>

A battery pack comprising a plurality of laminated batteries,
wherein at least 50% of the plurality of laminated batteries are laminated batteries according to any one of aspects 6 to 9.

### Advantageous Effects of Invention

According to the method of the disclosure it is possible to provide a laminated battery wherein the laminated battery units on the outermost sides are resistant to cracking. According to the disclosure it is possible to provide a battery pack comprising such a laminated battery.

### BRIEF DESCRIPTION OF DRAWINGS

FIG. 1A is a schematic diagram illustrating the method of the disclosure for producing a laminated battery.

FIG. 1B is a schematic diagram illustrating the method of the disclosure for producing a laminated battery.

FIG. 2A is a schematic diagram illustrating the method of the disclosure for producing a laminated battery.

FIG. 2B is a schematic diagram illustrating the method of the disclosure for producing a laminated battery.

FIG. 3 is a simplified cross-sectional view showing an example of a laminated battery of the disclosure.

FIG. 4 is a simplified cross-sectional view showing an example of the second end face of a laminated battery of the disclosure.

FIG. 5 is a simplified cross-sectional view showing an example of a laminated battery of the disclosure.

FIG. 6 is a simplified cross-sectional view showing an example of a laminated battery of the disclosure.

FIG. 7 is a schematic diagram showing an example of a battery pack of the disclosure.

FIG. 8 is a schematic diagram showing an example of a laminated battery of the prior art.

### DESCRIPTION OF EMBODIMENTS

An embodiment of the disclosure will now be described in detail with reference to the accompanying drawings. The disclosure is not limited to the embodiment described below, however, and various modifications may be implemented which do not depart from the gist thereof. The dimensional relationships in the drawings do not reflect actual dimensional relationships.

### <<Method for Producing Laminated Battery>>

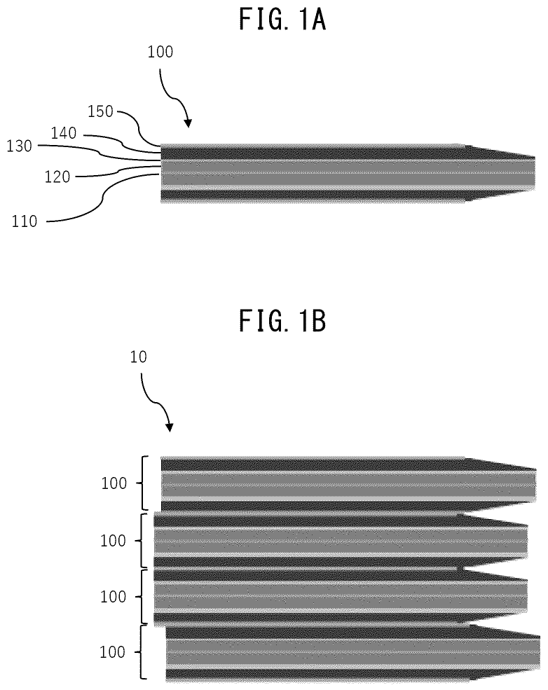

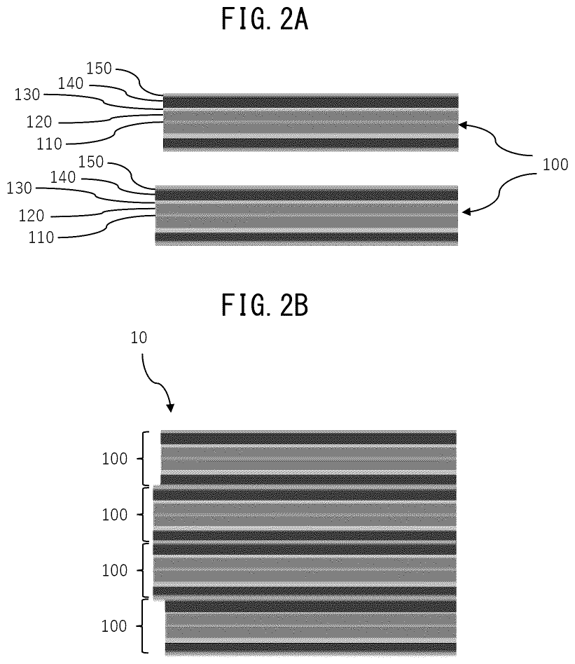

As illustrated in FIGS. 1 and 2, the method of the disclosure for producing a laminated battery 10 comprises the following steps: (a) providing a plurality of laminated battery units 100 each comprising a first current collector layer 110, a first electrode active material layer 120, a solid electrolyte layer 130, a second electrode active material layer 140 and a second current collector layer 150 in that order, and (b) stacking together the plurality of laminated battery units so that at least at a first end face of the laminated battery, the end faces of the outermost laminated battery units are situated further inward than the end faces of the other adjacent laminated battery units.

The present inventors considered that one of the reasons for cracking of the outermost laminated battery units 100 is that when a plurality of laminated battery units are stacked together, shifting takes place between the laminated battery units in the in-plane direction. For example, during the steps of producing the laminated battery 10, stress sometimes acts on the laminated battery in the stacking direction of the laminated battery units, due to pressing pressure on the laminated battery units 100 after stacking, constraining force when forming a battery module using the produced laminated battery, or impact such as vibration when the produced laminated battery is installed in a traveling body such as a vehicle and the traveling body moves. In such cases, excessive stress may act on the laminated battery units extending from the end faces of adjacent laminated battery units 100, as illustrated in FIG. 8. This problem becomes more notable when the laminated battery units extending from the end faces of the adjacent laminated battery units 100 are the outermost laminated battery units.

In this regard, the present inventors found that if a plurality of laminated battery units are stacked together in such a manner that the end faces of the outermost laminated battery units 100 are situated further inward than the end faces of the other adjacent laminated battery units, at least at a first end face of the laminated battery 10, as illustrated in FIGS. 1B and 2B, then it is possible to prevent concentration of stress on the outermost laminated battery units and to thus render the outermost laminated battery units resistant to cracking.

Regarding the disclosure, “laminated battery units” means elements that can form a laminated battery by being stacked together.

Also regarding the disclosure, “outermost laminated battery unit” means a laminated battery unit disposed on an outermost side in the stacking direction of the laminated battery unit. In other words, when laminated battery units are stacked in the vertical direction as illustrated in FIGS. 1B and 2B, for example, the “outermost side laminated battery units” are the laminated battery units disposed at the very top and the very bottom.

Moreover, “inward” means toward the center of the laminated battery unit 100 in the in-plane direction.

The method of the present disclosure will now be described in greater detail.

### <Step of Providing Laminated Battery Unit>

As illustrated in FIGS. 1A and 2A, the method of the disclosure for producing a laminated battery 10 comprises (a) providing a plurality of laminated battery units 100 each having a first current collector layer 110, a first electrode active material layer 120, a solid electrolyte layer 130, a second electrode active material layer 140 and a second current collector layer 150, in that order.

The method of providing each laminated battery unit 100 is not particularly restricted. For example, the laminated battery unit may be provided by stacking each layer of the laminated battery unit in a desired order. The method of stacking each layer is not particularly restricted, and for example, it may be a method of forming the first electrode active material layer 120, solid electrolyte layer 130 and second electrode active material layer 140 by compaction and stacking each layer in the desired order. Another method is one in which a composite slurry that can form each of the layers, i.e. the first electrode active material layer 120, solid electrolyte layer 130 and second electrode active material layer 140, is coated onto respective substrates and dried, and each layer is stacked in the desired order. The substrate for the first electrode active material layer 120 may be the first current collector layer 110, for example. The substrate for the solid electrolyte layer 130 may be a releasable metal foil, such as an aluminum foil. The substrate for the second electrode active material layer 140 may be the second current collector layer 150, for example.

When the second end face has an inclined surface 100a as described below, it is possible to provide a laminated battery unit by forming the first electrode active material layer, solid electrolyte layer and second electrode active material layer in that order on the first current collector layer in such a manner that at the second end face, the tip end of the first electrode active material layer is situated further inward than the tip end of the first current collector layer, the tip end of the solid electrolyte layer is situated further inward than the tip end of the first electrode active material layer and the tip end of the second electrode active material layer is situated further inward than the tip end of the solid electrolyte layer, and then by further stacking a second current collector layer on the second electrode active material layer. The first electrode active material layer, solid electrolyte layer and second electrode active material layer can be formed by repeatedly coating and drying a composite slurry capable of forming each layer. At the first end face, the stack as it is before stacking the second current collector layer may be cut parallel to the stacking direction to match the locations of the end faces of each of the layers in the in-plane direction of the laminated battery unit.

As long as the laminated battery unit 100 provided by the laminated battery unit providing step comprises the first current collector layer 110, first electrode active material layer 120, solid electrolyte layer 130, second electrode active material layer 140 and second current collector layer 150 in that order at least in one section, the order in which the layers are stacked at the other sections is not particularly restricted.

For example, the first electrode active material layer 120, solid electrolyte layer 130, second electrode active material layer 140 and second current collector layer 150 may be stacked in that order on both sides of the first current collector layer 110. The second current collector layer 150, second electrode active material layer 140, solid electrolyte layer 130, first electrode active material layer 120, first current collector layer 110, first electrode active material layer 120, solid electrolyte layer 130, second electrode active material layer 140 and second current collector layer 150 may be stacked in that order. In this case the “first current collector layer” and “first electrode active material layer” may be opposite from the “second current collector layer” and “second electrode active material layer”, respectively. In other words, when the “first current collector layer” and “first electrode active material layer” are the “positive electrode collector layer” and “positive electrode active material layer”, respectively, the “second current collector layer” and “second electrode active material layer” may be the “negative electrode collector layer” and “negative electrode active material layer”, respectively. Similarly, when the “first current collector layer” and “first electrode active material layer” are the “negative electrode collector layer” and “negative electrode active material layer”, respectively, the “second current collector layer” and “second electrode active material layer” may be the “positive electrode collector layer” and “positive electrode active material layer”, respectively.

The first current collector layer 110, first electrode active material layer 120, solid electrolyte layer 130, second electrode active material layer 140, second current collector layer 150, first electrode active material layer 120, solid electrolyte layer 130, second electrode active material layer 140 and first current collector layer 110 may also be stacked in that order, for example. In this case, both the “first current collector layer” and “second current collector layer” may be current collectors with the function of both a positive electrode collector and negative electrode collector, and the “first electrode active material layer” and “second electrode active material layer” may be either the “positive electrode active material layer” or “negative electrode active material layer”, respectively. In this case the laminated battery 10 produced by the method of the disclosure may be a bipolar battery.

### <Laminated Battery Unit Stacking Step>

As illustrated in FIGS. 1B and 2B, the method of the disclosure for producing a laminated battery 10 comprises (b) stacking together the plurality of laminated battery units so that at least at a first end face of the laminated battery, the end faces of the outermost laminated battery units 100 are situated further inward than the end faces of the other adjacent laminated battery units. In other words, the method includes stacking together the plurality of laminated battery units in such a manner that at one or both mutually opposite end faces, the end faces of the outermost ones are further inward than the end faces of the other adjacent laminated battery units. FIGS. 1B and 2B show stacking of four laminated battery units, but the number of laminated battery units in the laminated battery of the disclosure is not limited to four.

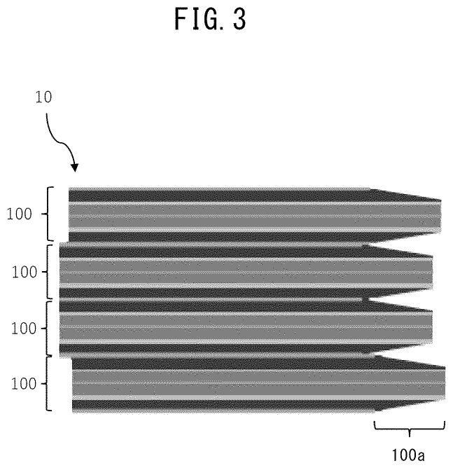

As illustrated in FIGS. 1B and 2B, the locations of the end faces of each of the layers forming each laminated battery unit at the first end face may match in the in-plane directions of the laminated battery units. In this case, stress tends to be concentrated at the outermost laminated battery units in a conventional laminated battery as illustrated in FIG. 3, tending to result in cracking of the outermost laminated battery units. In a laminated battery produced by the method of the disclosure, however, the plurality of laminated battery units are stacked together so that at least at the first end face, the end faces of the outermost laminated battery units are situated further inward than the end faces of the other adjacent laminated battery units, and therefore even if the locations of the end faces of each of the layers forming each laminated battery unit match each other in the in-plane direction of the laminated battery unit at the first end face, it is possible to prevent concentration of stress at the outermost laminated battery units and thus to inhibit cracking of the outermost laminated battery units.

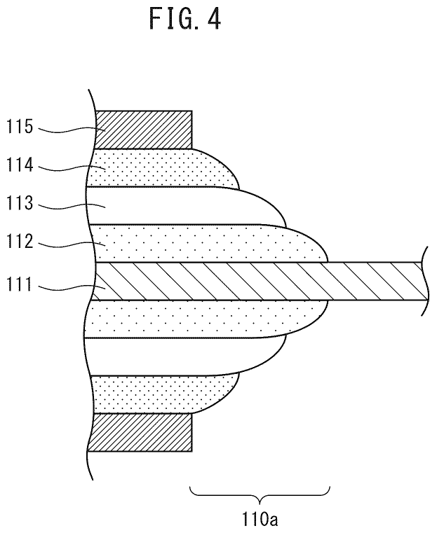

FIG. 3 is a simplified cross-sectional view showing a laminated battery of the disclosure produced by the method illustrated in FIG. 1. FIG. 4 is a magnified simple cross-sectional view of a second end face of a laminated battery of the disclosure. The shape is shown in simplified form in FIG. 3, but as illustrated in FIG. 4, the end faces of the first electrode active material layer, solid electrolyte layer and second electrode active material layer of the plurality of laminated battery units 100 may each have an inclined surface 100a toward the tip end, approaching the first current collector layer, in which case the inclined surface may be formed at the second end face opposite the first end face of the laminated battery 10. If the inclined surface is formed at the second end face, then locally applied stress on the outermost laminated battery units will be reduced compared to when the locations of the end faces match each other in the in-plane direction of the laminated battery units, thus helping to prevent cracking of the outermost laminated battery units.

The inclined surface may also be formed as a result of shorter lengths between the mutually opposite end faces of the second electrode active material layers 140, compared to the lengths between the mutually opposite end faces of the second electrode active material layers 120.

For example, in order to prevent deposition of dendrites in the negative electrode active material layer of a lithium ion secondary battery, the positive electrode active material layer is made smaller than the negative electrode active material layer in the in-plane direction. In this case, the “first electrode active material layer” may be the negative electrode active material layer and the “second electrode active material layer” may be the positive electrode active material layer. Alternatively, the “first current collector layer” may be the negative electrode collector layer and the “second current collector layer” may be the positive electrode collector layer. In this case, the second electrode active material layer as the positive electrode collector layer may extend at the first end face, and the first electrode active material layer as the negative electrode collector layer may extend at the second end face.

When all of the laminated battery units have an inclined surface at the second end face, the sizes of the laminated battery units may be the same or different.

As illustrated in FIG. 2B, the plurality of laminated battery units may be stacked in step (b) in such a manner that the end faces of the outermost laminated battery units 100 at the second end face opposite the first end face of the laminated battery 10 do not extend from the end faces of the other adjacent laminated battery units. With such a construction, it is possible to prevent concentration of stress on the outermost laminated battery units at the second end face as well, thus helping to prevent cracking of the outermost laminated battery units.

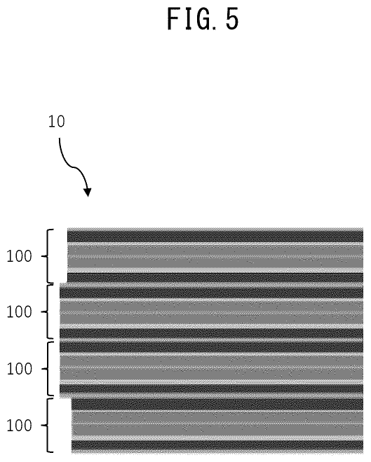

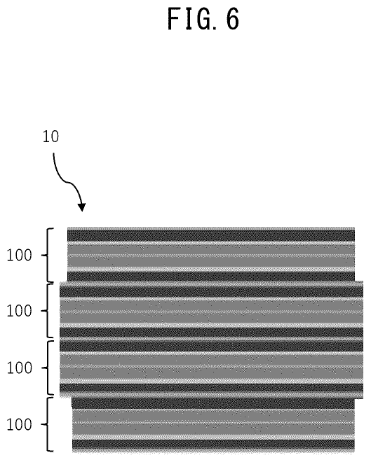

FIGS. 5 and 6 are simplified cross-sectional views each showing a laminated battery of the disclosure produced by the method illustrated in FIG. 2B. As illustrated in FIGS. 5 and 6, the locations of the end faces of each of the layers forming each laminated battery unit at the second end face may match each other in the in-plane direction of the laminated battery unit.

By providing a plurality of laminated battery units in which the lengths of the first end face and the second end face are different, and with the outermost laminated battery units having smaller lengths than the other adjacent laminated battery units, it is possible to stack together the plurality of laminated battery units in such a manner that the end faces of the outermost laminated battery units at the second end face of the laminated battery do not extend from the end faces of the other adjacent laminated battery units.

The positional relationship between the end faces of the outermost laminated battery units and the end faces of the other adjacent laminated battery units is not particularly restricted so long as the end faces of the outermost laminated battery units at the second end face of the laminated battery do not extend from the end faces of the other adjacent laminated battery units.

As illustrated in FIG. 5, for example, the plurality of laminated battery units may be stacked together in such a manner that the locations of the end faces of the outermost laminated battery units and the locations of the end faces of the other adjacent laminated battery units at the second end face of the laminated battery match each other in the in-plane direction.

Alternatively, as illustrated in FIG. 6, for example, the plurality of laminated battery units may be stacked together in such a manner that at the second end face of the laminated battery, the end faces of the outermost laminated battery units are situated further inward than the end faces of the other adjacent laminated battery units.

That “the end faces of the outermost laminated battery units at the second end face of the laminated battery do not extend from the end faces of the other adjacent laminated battery units”, regarding the present disclosure, also includes cases where the end faces of the outermost laminated battery units essentially do not extend from the end faces of the other adjacent laminated battery units. The phrase “essentially do not extend” means that the end faces of the outermost laminated battery units extend from the end faces of the other adjacent laminated battery units to a length of 150 μm or less, 100 μm or less, 50 μm or less, 30 μm or less, 10 μm or less, 5 μm or less or 1 μm or less.

Even for laminated battery units having inclined surfaces as described above, the plurality of laminated battery units may be stacked in such a manner that the end faces of the outermost laminated battery units at the second end face of the laminated battery do not extend from the end faces of the other adjacent laminated battery units.

The laminated battery units other than the outermost laminated battery units and the other adjacent laminated battery units may be stacked without any particular restriction to the locations of the end faces at the first end face of the laminated battery unit.

In step (b), the locations of the end faces of the outermost laminated battery units 100 at least at the first end face of the laminated battery 10 may be determined based on image processing. Specifically, the locations of the outermost laminated battery units may be determined, for example, by photographing the laminated battery units in the in-plane direction using a camera in an image processing device, and referencing the locations of the end faces of the other laminated batteries adjacent to the outermost laminated batteries. In this case, the locations of the outermost laminated battery units with respect to the reference may be set beforehand, and a computer may control a robotic arm so as to automatically position the outermost laminated battery units at the desired locations based on information relating to a reference in image data acquired from the camera, and on preset information relating to the locations of the outermost laminated battery units.

### <Other Steps>

The method of the disclosure may further comprise, after step (b), a step in which the plurality of laminated battery units that have been stacked together are pressed in the stacking direction. Even when the method of the disclosure includes such a pressing step, it is still possible to prevent concentration of stress on the outermost laminated battery unit, thus helping to prevent cracking of the outermost laminated battery units. The pressing method is not particularly restricted, and any common method may be employed.

The pressure during pressing is also not particularly restricted, and may be 0.1 MPa to 1 MPa, for example.

### <<Laminated Battery>>

As illustrated in FIGS. 3 and 4, in the laminated battery 10 of the disclosure, a plurality of laminated battery units 100 are stacked together. Each of the plurality of laminated battery units comprises a first current collector layer 110, a first electrode active material layer 120, a solid electrolyte layer 130, a second electrode active material layer 140 and a second current collector layer 150, in that order. At least at the first end face of the laminated battery, the end faces of the outermost laminated battery units are situated further inward than the end faces of the other adjacent laminated battery units.

With such a construction it is possible to prevent concentration of stress on the outermost laminated battery units, thus helping to prevent cracking of the outermost laminated battery units.

The laminated battery of the disclosure may be a lithium ion secondary battery, for example. Examples of battery uses include power sources for vehicles such as hybrid vehicles (HEV), plug-in hybrid vehicles (PHEV), electric vehicles (BEV), gasoline automobiles and diesel automobiles. The battery is most preferably used as a drive power supply unit for a hybrid vehicle (HEV), plug-in hybrid vehicle (PHEV) or electric vehicle (BEV). The battery of the disclosure may also be used as a power source for a traveling body other than a vehicle (such as a railway car, ship or aircraft), or as a power source for an electrical product such as an information processing device.

The elements composing the laminated battery of the disclosure will now be described.

### <Laminated Battery Unit>

At least at the first end face of the laminated battery 10, the spacings between the end faces of the outermost laminated battery units 100 and the end faces of the other adjacent laminated battery units may be 0.1 mm or greater and 1.0 mm or smaller, as viewed in the in-plane direction. The spacings may be 0.1 mm or greater, 0.2 mm or greater, 0.3 mm or greater, 0.4 mm or greater or 0.5 mm or greater, and 1.0 mm or smaller, 0.9 mm or smaller, 0.8 mm or smaller, 0.7 mm or smaller, 0.6 mm or smaller, 0.5 mm or smaller, 0.4 mm or smaller or 0.3 mm or smaller. The spacings are preferably within these ranges from the viewpoint of resistance to cracking of the outermost laminated battery units, and structural efficiency of the laminated battery in the in-plane direction.

In the laminated battery 10 of the disclosure, the end faces of the first electrode active material layer, solid electrolyte layer and second electrode active material layer of each laminated battery unit 100 may all have inclined surfaces toward the tip ends, approaching the first current collector layer, in which case the inclined surfaces may be formed from the second end face opposite the first end face of the laminated battery.

In the laminated battery 10 of the disclosure, the outermost laminated battery units 100 at the second end face opposite the first end face of the laminated battery do not need to extend from the end faces of the other adjacent laminated battery units.

The number of laminated battery units is not particularly restricted. The number may be 3 or greater, 4 or greater, 5 or greater, 6 or greater, 7 or greater, 8 or greater, 9 or greater or 10 or greater, and 50 or less, 45 or less, 40 or less, 35 or less, 30 or less or 25 or less, for example.

The thickness of each laminated battery unit is not particularly restricted and may be set as appropriate use of the laminated battery. For example, the thickness of each laminated battery unit may be 50 μm or greater, 100 μm or greater or 150 μm or greater, and 500 μm or smaller, 400 μm or smaller, 300 μm or smaller, 250 μm or smaller or 200 μm or smaller.

The shape of each laminated battery unit in the in-plane direction is not particularly restricted and may be quadrilateral, for example.

The size of each laminated battery unit is not particularly restricted and may be appropriately designed according to the properties desired for the battery, for example.

The constituent members of the laminated battery unit of the disclosure will now be described.

For convenience in explanation, each member will be described in terms of a laminated battery unit for a lithium ion secondary battery as the solid-state battery, but the laminated battery of the disclosure is not limited to this. The term “solid-state battery” as used herein refers to a battery using at least a solid electrolyte as the electrolyte, and the solid-state battery may also employ a combination of a solid electrolyte and a liquid electrolyte as the electrolyte. The solid-state battery of the disclosure may also be an all-solid-state battery, i.e. a battery employing only a solid electrolyte as the electrolyte.

### (Positive Electrode Collector Layer)

The conductive material used in the positive electrode collector layer is not particularly restricted and may be SUS, aluminum, copper, nickel, iron, titanium or carbon, for example.

The form of the positive electrode collector layer is not particularly restricted and may be, for example, a foil, sheet, mesh, porous body or the like. A foil is preferred among these.

The positive electrode collector layer may extend from the end faces of the laminated battery units, with a plurality of positive electrode collector layers joined at the extending part. The positive electrode collector layer may also extend from the first end face of the laminated battery unit, for example.

### (Positive Electrode Active Material Layer)

The positive electrode active material layer also includes at least a positive electrode active material, and it preferably further includes the solid electrolyte described below. In addition, it may include additives used in positive electrode active material layers for solid-state batteries, such as conductive aids and binders, for example, depending on the application and the purpose of use.

The material of the positive electrode active material is not particularly restricted. Examples for the positive electrode active material include heterogenous element-substituted Li—Mn spinel having a composition represented as lithium cobaltate (LiCoO₂), lithium nickelate (LiNiO₂), lithium manganate (LiMn₂O₄), Li_{1.5}Co_{1/3}Ni_{1/3}Mn_{1/3}O₂, LiCo_{1/3}Ni_{1/3}Mn_{1/3}O₂ or Li₁₊ₓMn_{2-x-y}M_{y}O₄ (where M is one or more metal elements selected from among Al, Mg, Co, Fe, Ni and Zn).

The conductive aid is not particularly restricted. For example, the conductive aid may be a carbon material such as VGCF (Vapor Grown Carbon Fibers) or carbon nanofibers, or a metal material.

The binder is also not particularly restricted. For example, the binder may be a material such as polyvinylidene fluoride (PVdF), carboxymethyl cellulose (CMC), butadiene rubber (BR) or styrene-butadiene rubber (SBR), or a combination thereof.

### (Solid Electrolyte Layer)

The solid electrolyte layer includes at least a solid electrolyte. The solid electrolyte used is not particularly restricted, and it may be any material that can be used as a solid electrolyte for a solid-state battery. For example, the solid electrolyte may be a sulfide solid electrolyte, an oxide solid electrolyte or a polymer electrolyte, although this is not limitative.

Examples of sulfide solid electrolytes include, but are not limited to, sulfide-based amorphous solid electrolytes, sulfide-based crystalline solid electrolytes and argyrodite solid electrolytes. Specific examples of sulfide solid electrolytes include, but are not limited to, Li₂S-P₂S₅ (Li₇P₃S₁₁, Li₃PS₄, Li₂P₂S₉), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂), LiI—Li₂S—P₂O₅, LiI—Li₃PO₄—P₂S₅ and Li₇₋ₓPS₆₋ₓClₓ, as well as combinations thereof.

Examples of oxide solid electrolytes include, but are not limited to, Li₂La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄ and Li₃₊ₓPO₄₋ₓNₓ(LiPON).

Polymer electrolytes include, but are not limited to, polyethylene oxide (PEO) and polypropylene oxide (PPO), and their copolymers.

The solid electrolyte may be glass or crystallized glass (glass ceramic). The solid electrolyte layer may include a conductive aid or a binder, for example, as necessary, in addition to the solid electrolyte mentioned above. The conductive aid and binder may be understood by referring to the aforementioned description regarding the positive electrode active material layer.

### (Negative Electrode Active Material Layer)

The negative electrode active material layer includes at least a negative electrode active material, and it preferably further includes the solid electrolyte described above. In addition, it may include additives used in negative electrode active material layers for solid-state batteries, such as conductive aids and binders, for example, depending on the application and the purpose of use.

The material for the negative electrode active material is not particularly restricted, but it is preferably one that is capable of occluding and releasing metal ions such as lithium ions. For example, the negative electrode active material may be, but is not limited to, an oxide-based negative electrode active material, alloy-based negative electrode active material or carbon material.

Oxide-based negative electrode active materials are not particularly restricted and include lithium titanate (LTO) particles.

Alloy-based negative electrode active materials are not particularly restricted, and examples include Si alloy-based negative electrode active materials and Sn alloy-based negative electrode active materials. Examples of Si alloy-based negative electrode active materials include silicon, silicon oxides, silicon carbides, silicon nitrides, and their solid solutions. A Si alloy-based negative electrode active material may also include elements other than silicon, such as Fe, Co, Sb, Bi, Pb, Ni, Cu, Zn, Ge, In, Sn and Ti, for example. Examples of Sn alloy-based negative electrode active materials include tin, tin oxides, tin nitrides, and their solid solutions. A Sn alloy-based negative electrode active material may also include elements other than tin, such as Fe, Co, Sb, Bi, Pb, Ni, Cu, Zn, Ge, In, Ti and Si, for example.

Carbon materials are not particularly restricted and include hard carbon, soft carbon and graphite, for example.

The solid electrolyte to be used in the negative electrode active material layer will be understood by referring to the aforementioned description of the solid electrolyte layer, while the conductive aid and binder will be understood by referring to the aforementioned description of the positive electrode active material layer.

### (Negative Electrode Collector Layer)

The conductive material used in the negative electrode collector layer is not particularly restricted and may be, but is not limited to, SUS, aluminum, copper, nickel, iron, titanium or carbon, for example.

The form of the negative electrode collector layer is not particularly restricted and may be, for example, a foil, sheet, mesh, porous body or similar. A foil is preferred among these.

The negative electrode collector layer may extend from the end faces of the laminated battery units, with a plurality of negative electrode collector layers joined at the extending part. The negative electrode collector layer may also extend from the second end face of the laminated battery unit, for example.

The laminated battery of the disclosure may also comprise elements other than the laminated battery units. For example, the laminated battery may comprise an exterior body and collector terminals.

### <Exterior Body>

The exterior body may be an external can or laminate film.

When the exterior body is an external can, a battery case may be formed by an external can that houses the laminated battery and has an opening, and a sealing plate that seals the opening. The external can may be made of a metal material such as stainless steel or aluminum.

When the exterior body is a laminate film, the laminate film may house the laminated battery. Specifically, the laminate film may house the laminated battery by being wound around the laminated battery. Alternatively, the laminate film may be constructed of first and second films, in which case it may sandwich and house the laminated battery with the first and second films from above and below in the stacking direction of the laminated battery.

The laminate film may have a sealant resin layer, a metal layer and a protective resin layer, in that order along the thickness direction. Examples of materials for the sealant resin layer include olefin-based resins such as polypropylene (PP) and polyethylene (PE). Examples of materials for the metal layer include aluminum, aluminum alloy and stainless steel. Examples of materials for the protective resin layer include polyethylene terephthalate (PET) and nylon.

The thicknesses of the layers forming the laminate film and of the laminate film itself are not particularly restricted. The thickness of the sealant resin layer may be 40 μm to 100 μm, for example. The thickness of the metal layer may be 30 μm to 60 μm, for example. The thickness of the protective resin layer may be 20 μm to 60 μm, for example. The thickness of the laminate film may be 80 μm to 250 μm, for example.

### <Collector Terminals>

The collector terminals may each be electrically connected to a current collector layer of the laminated battery. The material of the collector terminals is not particularly restricted so long as it has a current collection function, and examples include aluminum and stainless steel. The positive electrode and negative electrode collector terminals may be disposed opposite the pair of end faces of the laminated battery. When the inclined surfaces are to be formed on the second end face, the positive electrode collector terminal may be disposed opposite the first end face and the negative electrode collector terminal may be disposed opposite the second end face.

The sizes and shapes of the collector terminals are not particularly restricted.

When the battery of the disclosure has collector terminals, the laminate film may house the laminated battery together with the collector terminals. Specifically, the laminate film may house the laminated battery together with the collector terminals by winding together the laminated battery and the collector terminals. The laminate film may also be constructed of first and second films, in which case the first and second films may sandwich the laminated battery and collector terminals from above and below in the stacking direction of the laminated battery, housing the laminated battery together with the collector terminals.

### <<Battery Pack>>

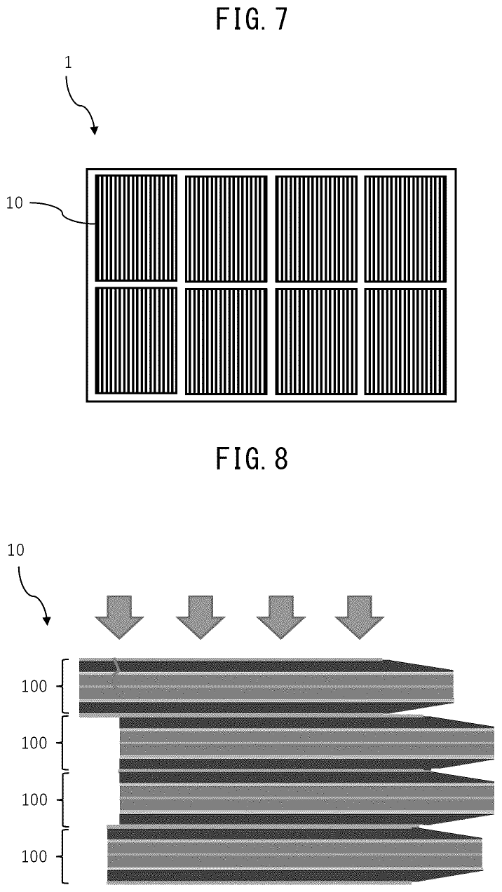

As illustrated in FIG. 7, the battery pack 1 of the disclosure comprises a plurality of laminated batteries 10. In the battery pack of the disclosure, at least 50%, at least 60%, at least 70%, at least 80%, at least 90%, at least 95% or at least 99% of the plurality of laminated batteries are laminated batteries 10 of the disclosure, i.e. laminated batteries in which, at least at the first end face, the end faces of the outermost laminated battery units 100 are situated further inward than the end faces of the other adjacent laminated battery units. The proportion of laminated batteries with cracking at the outermost laminated battery unit can be reduced with this type of battery pack. The laminated battery 10 of the disclosure will be understood by referring to the laminated battery of the disclosure as described above.

The number of laminated batteries in the battery pack of the disclosure is not particularly restricted and may be 2 or more, 4 or more, 6 or more, 8 or more or 10 or more, and 50 or less, 40 or less, 30 or less or 20 or less.

The battery pack may also comprise elements other than the plurality of laminated batteries. For example, the battery pack may comprise an exterior body which houses the plurality of laminated batteries. The material, shape and size of the exterior body is not particularly restricted and may be as commonly employed for battery pack exterior bodies.

### EXAMPLES

### Example

### <Providing Laminated Battery Unit>

A stack was obtained by forming a negative electrode active material layer, solid electrolyte layer and positive electrode active material layer in that order on a negative electrode collector layer, in such a manner that at the second end face, the tip end of the negative electrode active material layer was situated further inward than the tip end of the negative electrode collector layer, the tip end of the solid electrolyte layer was situated further inward than the tip end of the negative electrode active material layer, and the tip end of the positive electrode active material layer was situated further inward than the tip end of the solid electrolyte layer. The obtained stack was cut at the first end face, parallel to the stacking direction of the stack. A positive electrode collector layer was formed on the positive electrode active material layer of the stack to obtain a laminated battery unit. The locations of the end faces of each of the layers forming each laminated battery unit at the cut first end face matched each other in the in-plane direction of the laminated battery unit. In contrast, at the second end face which was not cut, the end faces of the negative electrode active material layer, solid electrolyte layer and positive electrode active material layer all had inclined surfaces toward the tip ends, approaching the negative electrode collector layer.

### <Fabrication of Laminated Battery>

A laminated battery was fabricated by stacking together 30 laminated battery units in such a manner that at the first end face of the laminated battery, the end faces of the outermost laminated battery units were situated 0.5 mm inward from the end faces of the other adjacent laminated battery units. The thickness of the laminated battery unit was 150 μm.

### COMPARATIVE EXAMPLE

A laminated battery was fabricated in the same manner as the Example except that 30 laminated battery units were stacked together in such a manner that at the first end face of the laminated battery, the end faces of the outermost laminated battery units were situated 0.5 mm outward from the end faces of the other adjacent laminated battery units.

### <<Evaluation>>

The laminated battery of each Example was evaluated for any defects generated in the outermost laminated battery units when pressing in the stacking direction. The pressing pressures used were 0.1 MPa and 1 MPa. Samples with no defects in the outermost laminated battery units were evaluated as “G”, those with small cracks were evaluated as “F”, and those with larger cracking were evaluated as “P”. The evaluation results are shown in Table 1.

TABLE 1

Pressure

| | 0.1 MPa | 1 MPa |
|---|---|---|
| Example | G | G |
| Comparative Example | F | P |

As shown in Table 1, no defects were produced in the outermost laminated battery units of the laminated battery of the Example.

### REFERENCE SIGNS LIST

1 Battery pack
10 Laminated battery
100 Laminated battery unit
100a Inclined surface
110 First current collector layer
120 First electrode active material layer
130 Solid electrolyte layer
140 Second electrode active material layer
150 Second current collector layer

1. A method for producing a laminated battery, comprising the following steps:
(a) providing a plurality of laminated battery units each comprising a first current collector layer, a first electrode active material layer, a solid electrolyte layer, a second electrode active material layer and a second current collector layer in that order, and
(b) stacking together the plurality of laminated battery units so that at least at a first end face of the laminated battery, the end faces of the outermost laminated battery units are situated further inward than the end faces of the other adjacent laminated battery units.

2. The method according to claim 1, wherein the end faces of the first electrode active material layers, solid electrolyte layers and second electrode active material layers of the plurality of laminated battery units all have inclined surfaces toward their tips, approaching the first current collector layer, and the inclined surfaces are formed at a second end face opposite the first end face of the laminated battery.

3. The method according to claim 2, wherein each inclined surface is formed because the lengths between the mutually opposite end faces of the second electrode active material layers are shorter than the lengths between the mutually opposite end faces of the first electrode active material layers.

4. The method according to claim 1, wherein in step (b), the plurality of laminated battery units are stacked together in such a manner that the end faces of the outermost laminated battery units at the second end face opposite the first end face of the laminated battery do not extend from the end faces of the other adjacent laminated battery units.

5. The method according to claim 1, wherein in step (b), the positions of the end faces of the outermost laminated battery units at least at the first end face of the laminated battery are determined by image processing.

6. A laminated battery, comprising a plurality of laminated battery units stacked together, wherein:
each of the plurality of laminated battery units comprises a first current collector layer, a first electrode active material layer, a solid electrolyte layer, a second electrode active material layer and a second current collector layer in that order, and
at least at a first end face of the laminated battery, the end faces of the outermost laminated battery units are situated further inward than the end faces of the other adjacent laminated battery units.

7. The laminated battery according to claim 6, wherein the end faces of the first electrode active material layer, the solid electrolyte layer and the second electrode active material layer of the laminated battery unit all have inclined surfaces toward their tips, approaching the first current collector layer, and the inclined surfaces are formed at a second end face opposite the first end face of the laminated battery.

8. The laminated battery according to claim 6, wherein at the second end face opposite the first end face of the laminated battery, the outermost laminated battery units do not extend from the end faces of the other adjacent laminated battery units.

9. The laminated battery according to claim 6, wherein at least at the first end face of the laminated battery, the spacings between the end faces of the outermost laminated battery units and the end faces of the other adjacent laminated battery units are 0.1 mm or greater and 1.0 mm or smaller, as viewed in the in-plane direction.

10. A battery pack comprising a plurality of laminated batteries,
wherein at least 50% of the plurality of laminated batteries are laminated batteries according to claim 6.
